(19) United States
(12) Patent Application Publication
(10) Pub. No.: US 2004/0214140 A1
(43) Pub. Date: Oct. 28, 2004

(54) Anatomical preformed tray incorporating a severable handle

(75) Inventors: Dan E. Fischer, Sandy, UT (US); Bruce S. McLean, Sandy, UT (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(73) Assignee: Ultradent Products, Inc.

(21) Appl. No.: 10/423,242

(22) Filed: Apr. 25, 2003

(51) Int. Cl. A61C 5/00

(52) U.S. Cl. 433/215

(57) ABSTRACT

A preformed dental tray including a severable handle and/or an anatomically curved bottom wall may be used to form a customized dental tray. The bottom wall of the preformed tray may be anatomically curved so as to more closely approximate the person's occlusal profile. A severable handle is attached to the front wall of the tray at two widely spaced points so that it provides support to the tray during forming, but is easily and cleanly removed once customization is complete. The tray is heated to become plastically deformable and placed over at least a portion of the person's teeth in order to form an impression of the person's teeth to yield an intermediate customized dental tray. Upon cooling sufficiently, the intermediate tray is removed from the persons' mouth and trimmed as needed to yield a finished customized tray corresponding to the person's teeth. The customized dental tray is useful for teeth bleaching and other dental treatments known in the art.

### BACKGROUND OF THE INVENTION

1. The Field of the Invention

The present invention is in the field of customized dental trays used to provide a desired dental treatment to a person's teeth. More particularly, the invention relates to customized dental trays that are formed using either a person's teeth or a stone model of the person's teeth as a template. The tray can be used for dental treatments such as bleaching, administration of fluoride, or application of other medicines.

2. The Relevant Technology

Virtually all people desire white or whiter teeth. To achieve this goal, people either have veneers placed over their teeth or have their teeth chemically bleached. In the past, patients who desired to have their teeth bleached had to submit to conventional in-office bleaching techniques. The process generally involves: (1) making an alginate impression of the patient's teeth; (2) making a stone cast or model of the impression; (3) vacuum forming a dental tray from the model, usually from a sheet of thin ethyl vinyl acetate (EVA) material, and trimming to exclude gingival coverage. This method results in a tray that is soft and flexible, that is very accurately customized to the patient's teeth, but the method is time consuming and the resulting tray is expensive.

Because of the high cost of these very accurate custom trays, less costly alternatives have been developed but these alternatives have substantial disadvantages in terms of handling during forming and accuracy and comfort of the finished customized tray.

One alternative is the so-called “boil and bite” tray. A relatively thick, non-custom preformed tray (similar to a mouth guard) made of EVA or polyethylene or other material is submerged in boiling water. Upon removal from the water, the tray is quickly placed inside the patient's mouth. The patient quickly applies contact pressure to make an impression of the biting surfaces of the user's teeth. One problem with “boil and bite” trays is that they are relatively thick and bulky, which make them intrusive and uncomfortable to wear. The thickness of large, bulky preform trays also limits the accuracy with which they can conform to the user's teeth and/or gums.

To the extent that preform trays made from EVA and like materials are made with thinner walls, such trays are extremely difficult to work with because they tend to shrivel and collapse outside extremely narrow windows of temperature and heating time. For example, if left in a hot water bath too long (i.e., for more than a few seconds) they can quickly become limp and lose their pre-form shape, making it difficult or impossible to make an impression of the user's teeth. In view of the foregoing, “boil and bite” trays that do not have the tendency to collapse and shrivel when heated generally do not accurately conform to the user's teeth and are bulky and uncomfortable to wear.

Another alternative for teeth bleaching involves non-customized strips of a flexible plastic material coated with a bleaching agent that can be applied to the teeth. Such strips are placed against the teeth by the user to cover the teeth. Because such strips are flimsy and limp at room temperature (i.e., they are not resilient or rigid), they are not useful for creating a customized dental tray.

Another alternative is a dual tray assembly as disclosed in U.S. Pat. No. 5,616,027 to Jacobs et al. The dual tray assembly is composed of an outer tray that supports or carries an inner tray made of a thermoplastic material comprising EVA. In use, the tray assembly is submerged in hot water, where the inner tray becomes pliable and moldable and the outer tray remains rigid. “Because of the material and the thinness of the walls of the inner tray, the inner tray will substantially lose integrity of its shape and form during the heating process . . . .” (Col. 4, ll. 14-16.) Thus, “[t]he carrier tray is necessary during the heating, handling and forming process.” (Col. 4, ll. 16-17.) The heated assembly is then placed in the mouth of the patient where the inner tray takes an impression of the person's teeth. The generally thinner inner tray results in a final tray that is much thinner and more comfortable to wear compared to conventional “boil and bite” trays that are sufficiently thick that they do not need a supporting carrier tray. Nevertheless, the outer tray can inhibit accurate conformation of the inner tray to the shape of the patient's teeth.

It would be an advantage to provide a customized tray that is thin-walled, flexible, comfortable, and that accurately reflects the shape of the person's dental arch while providing a severable handle for handling the tray during formation that leaves no rough area once the handle is removed from the tray.

### SUMMARY OF THE INVENTION

The present invention is directed to preformed dental trays that in one aspect are formed with an anatomically curved bottom wall. Because an anatomically curved bottom wall more closely approximates the person's actual occlusal profile, the result is a final customized tray that more accurately conforms to the person's dental arch. In another aspect, the invention relates to preformed trays that incorporate a severable handle. The severable handle is useful during heating of the tray, and is easily removed once the customization process is complete. Upon cooling, the customized tray retains its shape so that it can be used repeatedly as needed to provide a dental treatment.

The outer configuration of the preformed dental tray is preferably a horseshoe shape, with a bottom wall and side wall(s) having either an open U-shaped cross-section or an L-shaped cross section to generally fit over at least the labial surface of the upper and/or lower teeth. The front and rear walls of a U-shaped preformed tray may be either parallel or flared, the latter providing a larger top opening than the width of the tray bottom. The tray is such that there are no sharp internal angles for increased comfort and to prevent bunching of the tray material during customization.

The bottom wall of the preformed tray may be anatomically curved. A person's upper dental arch exhibits an occusal profile that is gently curved in the area of the molars, and the profile curves substantially downward as the upper incisors are reached. Similarly, a person's lower teeth's occlusal profile is gently curved in the area of the molars, and the profile curves substantially upward as the lower incisors are reached. This curvature of the upper and lower occlusal profiles is known as the curve of Spee. Incorporating an anatomically curved bottom wall results in a preformed tray that more closely conforms to the actual profile of the patient's teeth. In particular, the bottom wall of the tray takes into account the non-planar occlusal profile of the teeth, especially the incisors. This results in a finished, customized tray that more accurately conforms to the person's teeth, which also makes the tray more comfortable to wear.

The tray includes a handle, attached at two widely spaced points, preferably along the front upper portion of the tray. Attaching the handle at two widely spaced points provides for sufficient mechanical support and stability while handling the tray, and also facilitates clean and easy removal of the handle once the tray is fully customized. Attaching the handle at the top of the tray facilitates the cleanest removal of the handle once the tray is fully customized.

The tray preferably comprises ultra low density polyethylene (“ULDPE”), either alone or blended with one or more additional polymers, although materials other than ULDPE, preferably those currently used in the manufacturing of dental trays, such as ethylene-vinyl acetate, F-polycaprolactone, polyethylene, polypropylene, etc. may be used.

The tray is advantageously designed and formulated so as to soften when heated to a desired temperature above body temperature (i.e. 98.6° F.), preferably in a range of about 110° to about 180° F., more preferably in a range of about 120° to about 170° F., and most preferably in a range of about 130° to about 160° F. Upon heating to an appropriate temperature at or above its softening temperature, the tray becomes plastically deformable and moldable so that it can form an impression of the teeth or teeth and gums.

The tray customization process is done by immersing the preformed tray incorporating a severable handle into hot water or by exposing it to other suitable heating means known in the art (e.g., heat gun, oven or torch). The handle can be used to facilitate immersion of the tray in hot water or heating using other means while reducing the risk of burning one's fingers. The tray will typically become plastically deformable after being submerged within water heated to a temperature of about 160-212° F. or heated using other appropriate heating means within a prescribed period of time, preferably within about 1-30 seconds, more preferably within about 2-15 seconds, and most preferably within about 4-8 seconds.

When sufficiently softened and plastically deformable, the tray is placed over the person's upper and/or lower teeth and the person closes his or her mouth. A vacuum is advantageously created inside the tray by the patient sucking in a manner so as to draw air and/or water out from the space between the tray and tooth surfaces. Additional forming pressure can be applied by the person's tongue or by placing the patient's or dental practitioner's fingers against the outer surfaces of the tray.

As the tray remains in the person's mouth it begins to cool to body temperature. After the customized tray has been formed and cooled sufficiently so that it is no longer plastically deformable, it is removed from the person's mouth. The tray may be further cooled if desired, such as by placing the tray in cold water or by letting it air cool to room temperature. The formed tray will have an impression of the teeth and is therefore a “custom” or “customized” tray. Upon cooling, the tray may remain flexible and resilient but it will not be “plastically deformable” so as to assume a different resting conformation unless reheated and reshaped. If additional shaping is needed, either immediately or later, the tray may be heated and customized as before.

Once the customization process is complete, the detachable handle can be removed by e.g., cutting or tearing. The handle is attached at two widely spaced points along the front of the tray so that removal is clean and leaves only two small rough areas that are easily smoothed by sanding or other means. Because the two attachment points are widely spaced, the handle provides sufficient mechanical support when handling the tray. The customized tray is preferably trimmed to or shy of the gingival margin of the frontal and/or lingual surfaces. The tray is preferably scalloped around the interdental papilla in order to produce maximum customization and comfort. Nevertheless, the tray can be trimmed to cover a portion of the teeth, just the teeth, or to cover a portion of the gingiva in addition to the teeth, as desired.

The customized trays formed in this manner are useful for tooth bleaching or other dental treatments. Bleaching or other dental compositions can be applied to a person's teeth and/or gums by placing the composition into the customized tray and placing the tray over the person's teeth. The tray holds the dental composition against the person's teeth and/or gums and keeps it from being diluted by saliva or otherwise being prematurely removed. In a preferred embodiment, the dental composition may include an appropriate tackifying agent in order to make it sticky and viscous. The tray can be used once or as many times as desired to treat the person's teeth and/or gums.

These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a perspective view illustrating an embodiment of a preformed dental tray according to the invention that can be used to form a customized dental tray;

FIG. 1B is a different perspective view of the embodiment illustrated in FIG. 1A.

FIG. 1C is a partial cross-sectional view of the embodiment illustrated in FIGS. 1A and 1B;

FIG. 1D is a top view of the embodiment illustrated in FIGS. 1A-1C;

FIG. 2A is a perspective view illustrating an embodiment of a preformed dental tray according to the invention that can be used to form a customized dental tray;

FIG. 2B is a partial cross-sectional view of the embodiment illustrated in FIG. 1A;

FIG. 2C is a top view of the embodiment illustrated in FIGS. 2A and 2B;

FIG. 3 is a perspective view illustrating an alternate embodiment of a preformed dental tray according to the invention that can be used to form a customized dental tray;

FIGS. 4A and 4B illustrate alternative methods of applying a blockout material to a person's teeth (or stone cast) in order to yield a customized dental tray having reservoirs;

FIGS. 5A-5C illustrate alternative methods of heating a preformed tray in order to soften it preparatory to making a customized dental tray;

FIG. 6 illustrates a preformed dental tray being placed in a patient's mouth during formation of a custom-fitting tray using a person's teeth as a template;

FIG. 7 illustrates an intermediate customized dental tray being trimmed in order to remove excess tray forming material; and

FIG. 8 illustrates a customized dental tray according to the invention that has been trimmed and scalloped.

### DETAILED DESCRIPTION OF THE PREFERRED EMBODIMENTS

In one aspect, the invention relates to the use of preformed trays incorporating an anatomically curved bottom wall in making customized dental trays, either using a person's teeth or a stone cast of the person's teeth as a template. In another aspect, the invention relates to including a severable handle in the preformed tray. The handle is attached to the front of the tray at two widely spaced points, rather than connecting the handle along its entire length. The inventive dental trays can be used for any desired dental treatment, such as tooth bleaching, fluoride treatments, and antimicrobial treatments. Reference is now made to the drawings.

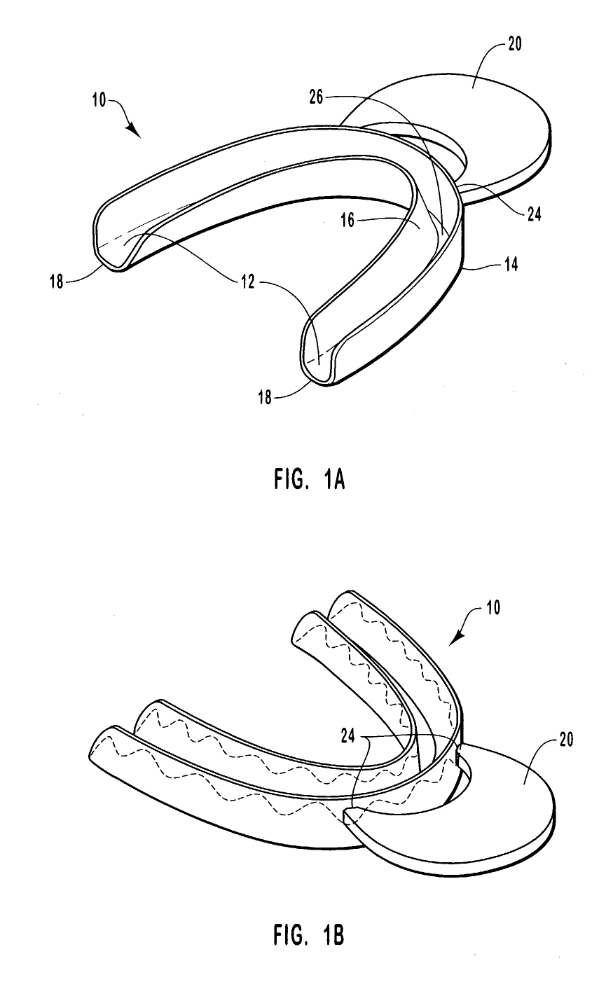

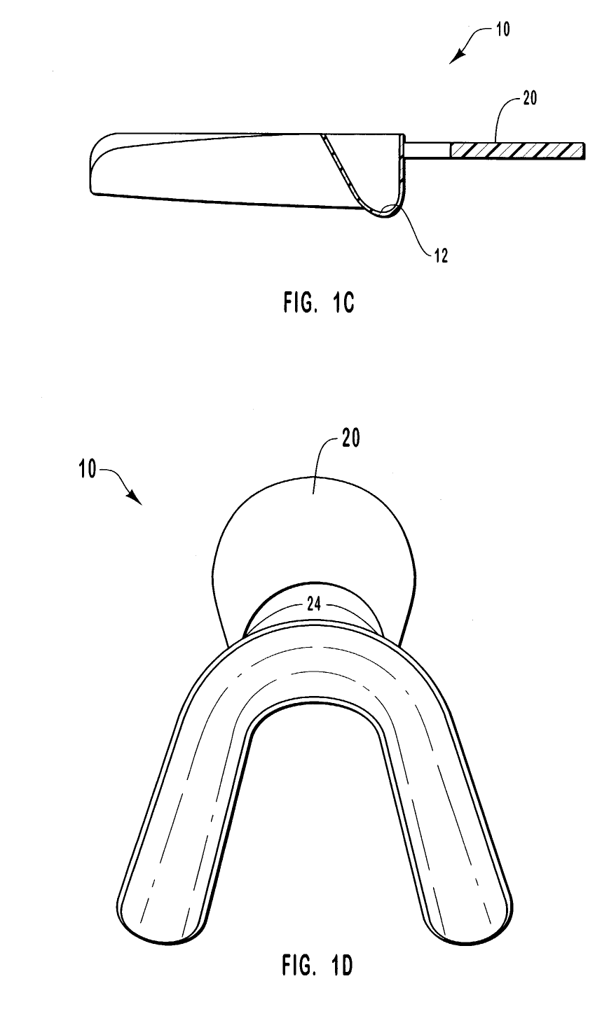

FIG. 1A depicts a preformed dental tray 10 that may be used to manufacture a customized dental tray according to the invention. The tray may be designed for an upper or a lower dental arch, the tray for the lower arch being somewhat smaller relative to the tray designed for the upper arch. The preformed tray 10 comprises a bottom wall 12 having a generally horseshoe shaped configuration generally conforming to the shape of the person's dental arch. The bottom wall 12 incorporates an anatomical curve, such that it more closely approximates the occlusal profile of a person's teeth. Generally, a person's upper molars have an occlusal profile that curves gently upward across the rear molars, while the lower molars have an occlusal profile that curves gently downward across the rear molars. As one moves toward the front teeth, past the bicuspids, canines, and to the incisors, the occlusal profile curves substantially downward with respect to the incisors of the upper arch and curves substantially upward with respect to the incisors of the lower arch. This curvature is known as the curve of Spee, and is perhaps best seen in the bottom wall curvature of FIG. 1C.

As used herein, the term anatomically curved refers to curving the bottom wall in such a way so as to follow the curvature of the dental profile (i.e. the curve of Spee). Using a preformed tray that incorporates an anatomically curved bottom wall allows the tray to better conform to the actual profile of the teeth, resulting in a more accurate fit and greater comfort for the patient. Because of this curvature, bottom wall 12 is curved along its entire length, with the curvature most pronounced near the center portion 26 of the tray 10.

The embodiment of preformed tray 10 illustrated in FIGS. 1A-1D further includes a front side wall 14 and a rear side wall 16 that, together with the bottom wall 12, form a U-shaped tray 10 that is open at the top and that terminates at ends 18. The tray is such that there are no sharp internal angles for increased comfort and to prevent bunching of the tray material during customization. For example, where the side walls and the bottom wall come together, any angles are smoothed so that there are no sharp internal angles.

A detachable handle 20 is attached to the tray 10 along an outer surface of the front side wall 14, preferably along the top of the side wall 14. The width of the handle 20 and spacing of the end points 24 can be any desired width, but end point spacing is preferably about 20-60 mm, more preferably about 1.5 inches (about 38 mm). Only the end points 24 of the handle are attached to the tray at front side wall 14. Attaching the handle in this manner advantageously provides mechanical support and stability while handling the tray (e.g. there is less tendency for the tray to twist when the handle is attached in this manner), and also facilitates clean and easy removal of the handle once the tray is fully customized. Removal of the handle is easier and leaves a smoother, more comfortable surface when the handle is attached at two end points rather than along the whole length of handle 20. Once handle 20 is removed by cutting or tearing, there may be two small rough points or areas where end points 24 were attached to front side wall 14, but these can be easily smoothed by sanding, etc.

Referring to FIG. 1B, optionally attaching the handle at the top of the front side wall 14 allows for the most comfortable surface when the handle is detached if the tray is also trimmed because trimming removes the small rough end points completely by removing the top portion of front side wall 14 to which the handle is attached. FIG. 1B illustrates the tray of FIG. 1A from a perspective that perhaps best illustrates this characteristic. The handle 20 is attached near the top of front side wall 14, above the final trimmed contour of the tray, which is illustrated in phantom to show how the handle and the end points 24 are completely removed when the tray is trimmed. Alternatively, a handle attached along the whole length of handle 20 may alternatively be used in this instance because trimming will also remove the entire rough area where the handle was connected.

The rear side wall 16 of the tray 10 may be flared with respect to the front wall 14 at the ends 18 of the horseshoe-shaped tray 10, but in any case gradually opens up near middle portion 26 of the tray so as to better accommodate the roof of the mouth near the middle portion 26 of the tray 10. Alternatively, rear side wall 16 may be substantially parallel to front wall 14 at ends 18. The bottom wall 12 has a lingual to labial width near the curved middle portion 26 of the tray that is advantageously less than the width of the bottom wall 12 at the ends 18 of the tray 10. This allows for the differences in the radial width of a person's incisors and canines relative to the bicuspids and molars. It should be understood, however, that dental trays incorporating a severable handle within the scope of the invention can have any desired configuration such that the tray of FIGS. 1A-1D is merely a nonlimiting example.

FIG. 1C illustrates the dental tray incorporating a severable handle and an anatomically curved bottom wall as a partial cross section through middle portion 26. This figure illustrates the deep anatomical curvature of the bottom wall 12 in the region of the incisors. As seen in the figure, the bottom wall 12 includes a deep curve at the front of the tray where the incisors and canines are placed. Bottom wall 12 also incorporates a gentle curvature in the region of the molars. This curvature of the bottom wall allows the tray to better conform to the actual dental profile (i.e. the curve of Spee).

FIG. 1D illustrates the dental tray incorporating a severable handle and an anatomically curved bottom wall from a perspective that highlights the attachment of the handle 20 and the varying lingual to labial width of bottom wall 12. Handle 20 is attached to the tray 10 preferably near the top of front side wall 14. As seen in the figure, the tray and handle are only attached at two widely spaced end points 24.

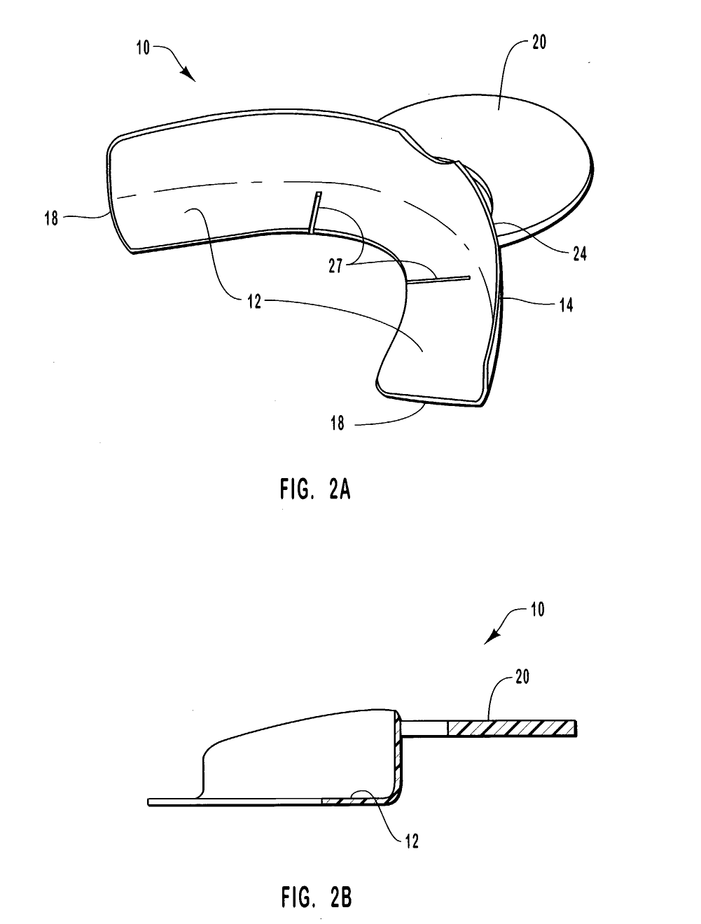

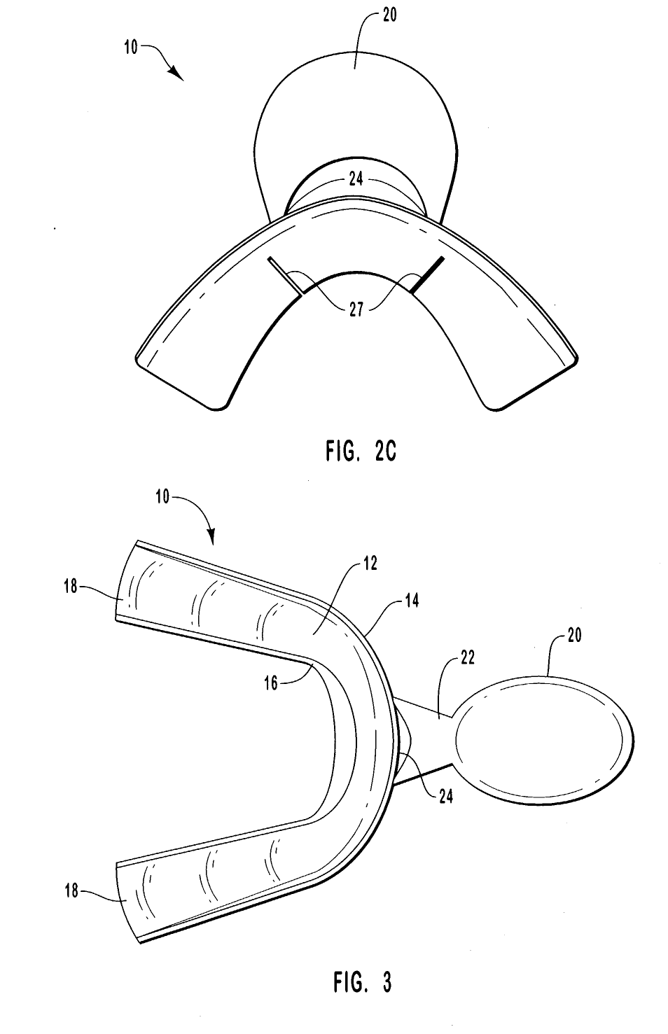

FIGS. 2A-2C illustrate another embodiment of the tray. As can be seen in FIG. 2A, this tray includes a bottom wall 12, a front wall 14, ends 18, a handle 20, and end points 24. This embodiment differs from that illustrated in FIGS. 1A-1D in that this tray embodiment does not include a rear side wall, which results in an L shaped tray. Such a tray is useful where treatment of only the labial surface of the patient's teeth is desired. As with the embodiment illustrated in FIGS. 1A-1D, where the front wall and the bottom wall come together, any angles are smoothed so that there are no sharp internal angles, which prevents bunching of the material during customization. As can be seen, especially in FIG. 2B, bottom wall 12 is illustrated without an anatomical curve, but is fairly flat and planar, although bottom wall 12 could alternatively incorporate an anatomical curve. A further difference is that bottom wall 12 may include one or more slots 27, which help maintain proper curvature of bottom wall 12. As can be seen in FIGS. 2B and 2C, the attachment of the handle 20 is similar to that illustrated in FIGS. 1A-1D.

FIG. 3 illustrates yet another embodiment of the tray. This tray includes a bottom wall 12, a front side wall 14, a rear side wall 16, ends 18, a handle 20, a neck 22, and end points 24. As with earlier illustrated embodiments, where the front wall and the bottom wall come together, any angles may be smoothed so that there are no sharp internal angles, which prevents bunching of the material during customization. Bottom wall 12 may be anatomically curved. This embodiment differs from that illustrated in FIGS. 1A-1D in that it includes a neck 22 between the handle 20 and the end points 24. As with the other embodiments, the width of the handle 20 and the spacing of the end points 24 may be at any desirable distance, although it is preferable to space the end points between about 20 mm and about 60 mm apart, and more preferably about 1.5 inches (about 38 mm) apart.

The tray 10 can be made of any appropriate thermoplastic material that is able to soften at a predetermined temperature greater than body temperature so as to become plastically deformable but that will maintain its shape when cooled to at or below body temperature. A preferred thermoplastic material is ultra low density polyethylene (ULDPE), which can be used alone or in combination with other polymers, such as polypropylene (PP), ethylene vinyl acetate (EVA), polycaprolactone (PCL), and other forms of polyethylene (PE). Although ULDPE is preferred, other materials such as EVA, PCL, PP, and PE can be used by themselves or blended to make the preformed dental tray. Flow additives and plasticizers may be added as desired.

ULDPE is the preferred thermoplastic material because of its ability to maintain its structural form and integrity even after being heated sufficiently so as to become plastically deformable.

ULDPE refers to a range of polyethylene-based copolymers defined as having a density of equal to or less than 0.914 g/cm³. By way of comparison, low density polyethylene (LDPE) is defined as having a density in a range of 0.915-0.94 g/cm³ and high density polyethylene (HDPE) is defined as having a density in a range of 0.94 to 0.97 g/cm³. Thus, ULDPE can be readily distinguished from other forms of PE by its density, although its physical properties also differ significantly in many respects, including water vapor transmission rate, crystallinity, melting point, coefficient of linear expansion, elasticity modulus, yield strength, tensile strength, hardness, and impact strength. In general, ULDPE is an ethylene copolymer characterized as having excellent environmental stress crack resistance, outstanding flex-life and flex-crack resistance, toughness and good sealability. It also has a relatively high melt flow index compared to conventional tray materials, which makes it uniquely suitable for use in manufacturing thin-walled customized dental trays. It has been found that, in general, the higher the melt flow index, the more the preformed trays made from the material will tend to maintain their shape after being heated to the material's softening temperature.

Examples of suitable ULDPE materials include various polymers sold under the general trade name Attane® by Dow Chemical. In general, Attane® refers to polyethylene copolymers made from ethylene and octene. Specific examples include Attane®) 4201 (density=0.912 g/cm³), Attane® 4202 (density=0.913 g/cm³), Attane® 4203 (density=0.905 g/cm³), Attane® 4301 (density=0.914 g/cm³), and Attane® 4404 (density=0.904 g/cm³). Another suitable ULDPE material is Exact® 4041 (density=0.878 g/cm³) made by Exxon-Mobil Chemical. An example of a suitable EVA material is Elvax® 250, available from Dupont. An example of a suitable PCL material is Capra® 650 from Solvoy-Interox. Other thermoplastic materials and blends used in making dental trays are disclosed in U.S. Pat. No. 5,769,633 to Jacobs et al., U.S. Pat. No. 5,051,476 to Uji et al., and U.S. Pat. No. 6,089,869 to Schwartz. For purposes of disclosing thermoplastic materials that can be made into dental trays, the foregoing patents are incorporated herein by reference.

In a preferred embodiment, the preformed tray 10 becomes plastically deformable at a predetermined temperature in a range of about of about 110° to about 180° F., more preferably in a range of about 120° to about 170° F., and most preferably in a range of about 130° to about 160° F. The preformed tray 10 preferably becomes plastically deformable after being immersed in water at a temperature of about 160-212° F. (or by heating using other appropriate heating means) within about 1-30 seconds, more preferably within about 2-15 seconds, and most preferably within about 4-8 seconds.

The preformed tray 10 may advantageously be made available in a variety of sizes to accommodate varying sizes of teeth and/or dental arches. This aids tray forming and customization because a preformed tray that more closely fits the patient's mouth and teeth size can be selected.

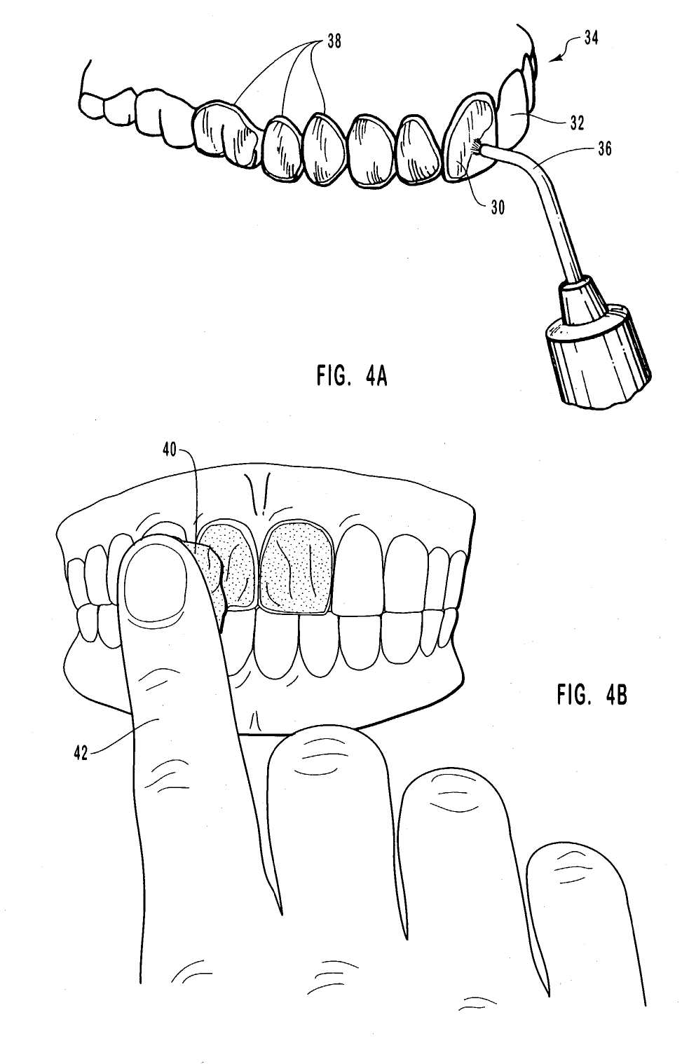

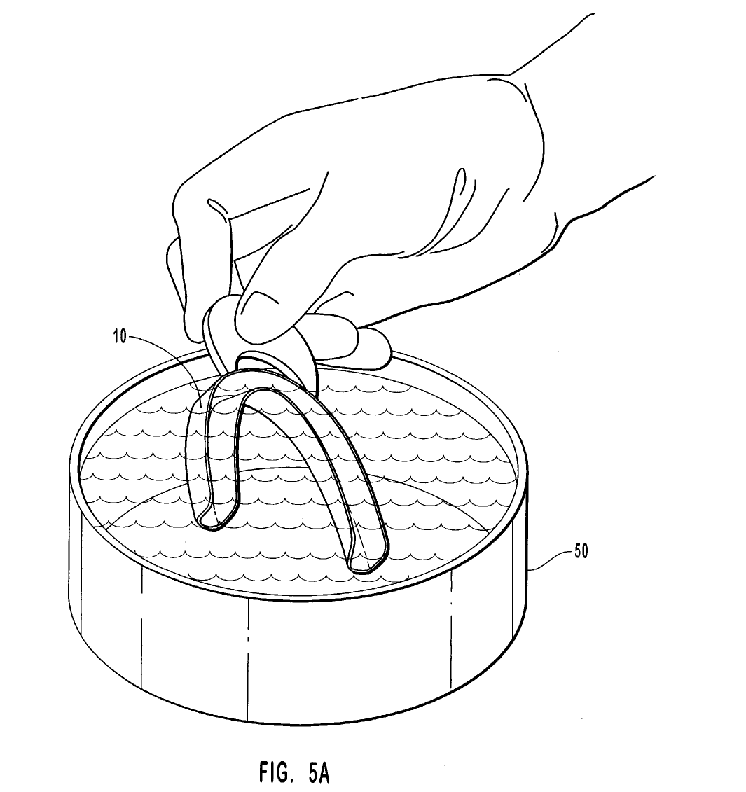

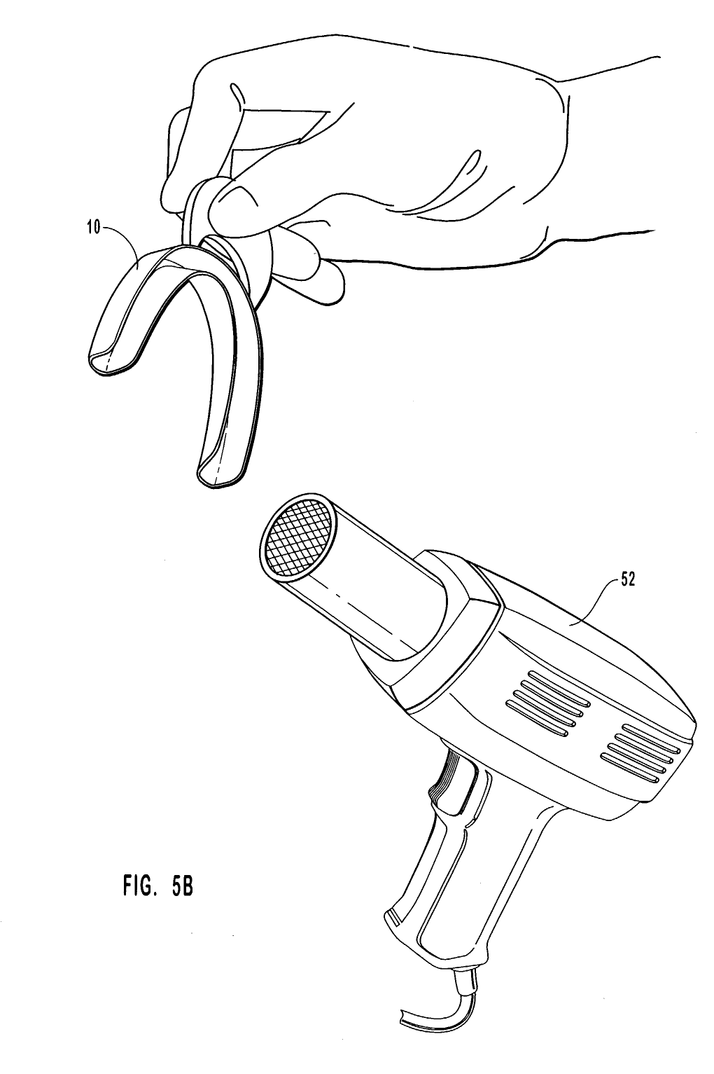

FIGS. 4A and 4B depict the optional use of a blockout material in order to yield a finished customized tray incorporating one or more reservoirs therein. Reservoirs may be desirable in order to provide additional dental composition adjacent to the teeth and/or gingival tissue being treated. Once a customized tray has been formed and then removed from the person's teeth, the blockout material is removed.

FIG. 4A depicts the application of a flowable blockout material 30 (e.g., a curable resin) onto the surfaces 32 of a person's teeth 34 (or stone cast) using a syringe tip 36 attached to a syringe (not shown). As shown therein, the flowable blockout material 30 may be applied so as to substantially cover the tooth surfaces 32 just shy of the gingival margin 38, although it is certainly within the scope to cover the entire tooth surface and/or at least a portion of the gingiva if desired (or the portions of the stone cast representative of the person's tooth surfaces and gingival margin).

FIG. 4B depicts the application of a wax, clay or putty blockout material 40 by pressing it against the tooth surfaces (or stone cast) using a person's finger 42. Alternatively, highly viscous blockout materials or clays may be applied and/or excess blockout material may be removed using an application tool (not shown), such as a spatula.

Although not required, the preformed tray 10 may include either an internal or external support to provide additional support as the tray is heated so as to become plastically deformable. When using a tray as that illustrated in FIGS. 1A-1D or FIG. 3 with a U shaped cross section, an open cell foam internal support may optionally be placed inside the tray. Such a support provides additional support to the tray while being heated. The internal support is easily removed just before placement of the tray over the person's teeth.

When using a tray as that illustrated in FIGS. 2A-2C with an L shaped cross section, a thin metal foil (e.g. aluminum foil) may optionally be placed on the exterior of the bottom wall of the tray to act as an external support. The external support provides additional support to the tray as it is heated, and may be removed either before or after placement of the tray over the person's teeth.

The use of internal or external supports as described above is optional, and not required. Simply altering the tray composition or using a slightly thicker tray can produce a tray that will have less tendency to collapse when heated so as to become plastically deformable. ULDPE as a tray material is preferred because it tends not to collapse but will substantially retain its shape even when relatively thin so that it can be readily molded into a customized dental tray.

In order to achieve the desired mechanical properties, both in the preformed tray and in the finished customized tray, when using ULDPE the bottom wall 12 will preferably have a thickness of about 0.4 mm to about 2 mm, more preferably in a range of about 0.6 mm to about 1.5 mm, and most preferably in a range of about 0.8 mm to about 1.3 mm. The front side wall 14 and rear side wall 16 preferably have wall thicknesses in a range of about 0.3 mm to about 1.8 mm, more preferably in a range of about 0.4 mm to about 1.4 mm, and most preferably in a range of about 0.7 mm to about 1.2 mm.

When using a material other than ULDPE, the bottom wall 12 will preferably have a thickness of about 0.8 mm to about 4 mm, more preferably in a range of about 1.2 mm to about 3 mm, and most preferably in a range of about 1.6 mm to about 2.6 mm. The front side wall 14 and rear side wall 16 preferably have wall thicknesses in a range of about 0.6 mm to about 3.6 mm, more preferably in a range of about 0.8 mm to about 2.8 mm, and most preferably in a range of about 1.4 mm to about 2.4 mm.

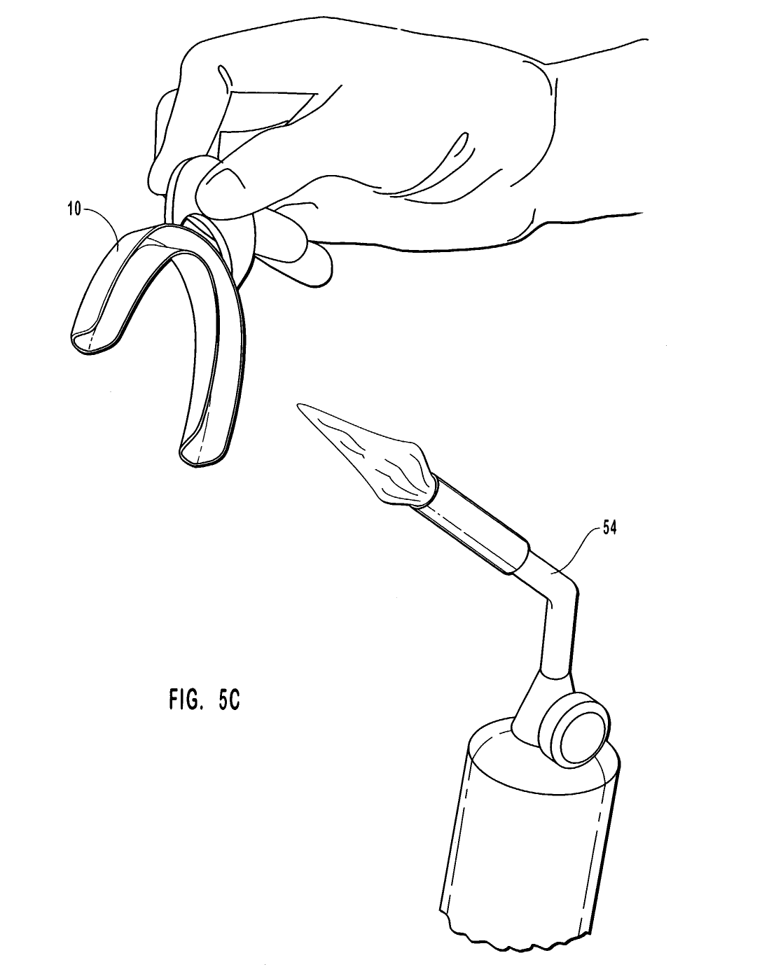

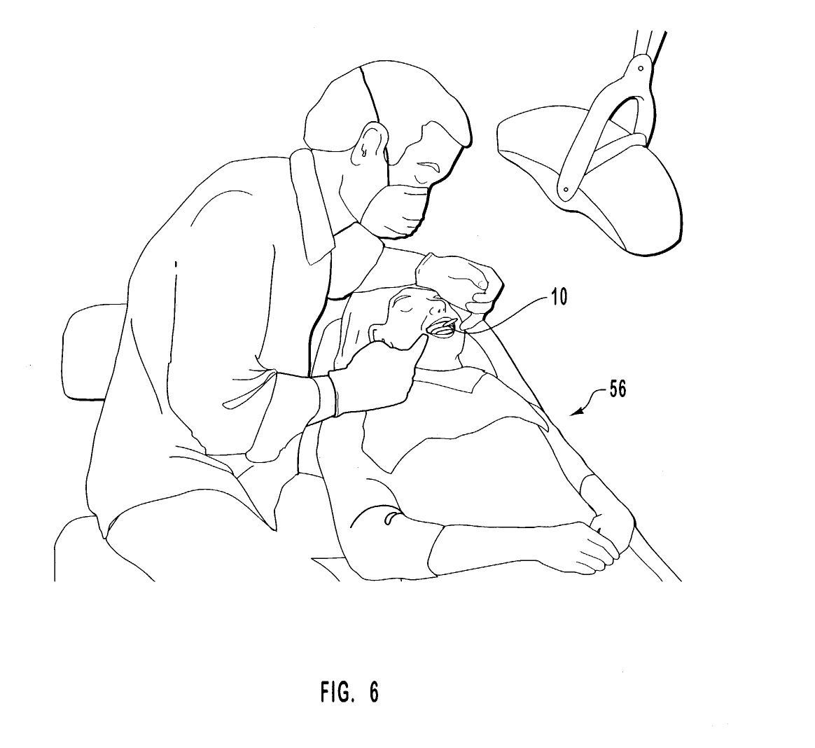

Reference is now made to FIGS. 5A-5C, which depict various methods for heating a preformed tray prior to forming the customized dental tray. FIG. 5A depicts a preformed tray 10 incorporating a severable handle immersed in a bath 50 of hot or boiling water or other suitable liquid. The handle 20 allows the tray 10 to be submerged easily by the user and will advantageously remain outside the bath 50 as shown in FIG. 5A. This allows the tray 10 to be easily removed from the bath 50 after being heated to the desired temperature. In the alternative, the handle 20 may be submerged in the bath 50 along with the tray 10 and then grasped using a pair of tongs or other suitable gripping device (not shown) in order to remove the tray 10 from the bath 50.

FIG. 5B depicts the alternative use of a heat gun 52 to heat the preformed dental dray 10. FIG. 5C depicts the alternative use of a torch 54 to heat the preformed dental dray 10. When using these alternative heat sources, care should be taken to heat the tray evenly, such as by moving the tray and/or heat source back and forth to avoid heating a single area to the exclusion of other areas.

Referring now to FIG. 6, after the tray 10 incorporating a severable handle has been heated sufficiently so as to assume a plastically deformable condition, the tray 10 is inserted into the mouth of a person 56 (e.g., a patient) over the upper or lower teeth and the patient 56 closes his or her mouth. The preformed tray is plastically deformed (i.e., molded) so as to conform and correspond to at least a portion of the person's teeth. The person may assist this process by sucking and creating a vacuum within the person's mouth. This causes any water and/or air interposed between the person's teeth and tray material to be removed so that the tray material can more closely conform to the shape of the person's teeth. Additional forming pressure can be applied by the fingers of the person or the fingers of another assisting in the formation of the customized tray. The person may also use his or her tongue to press the tray material more closely against the lingual and/or frontal tooth surfaces.

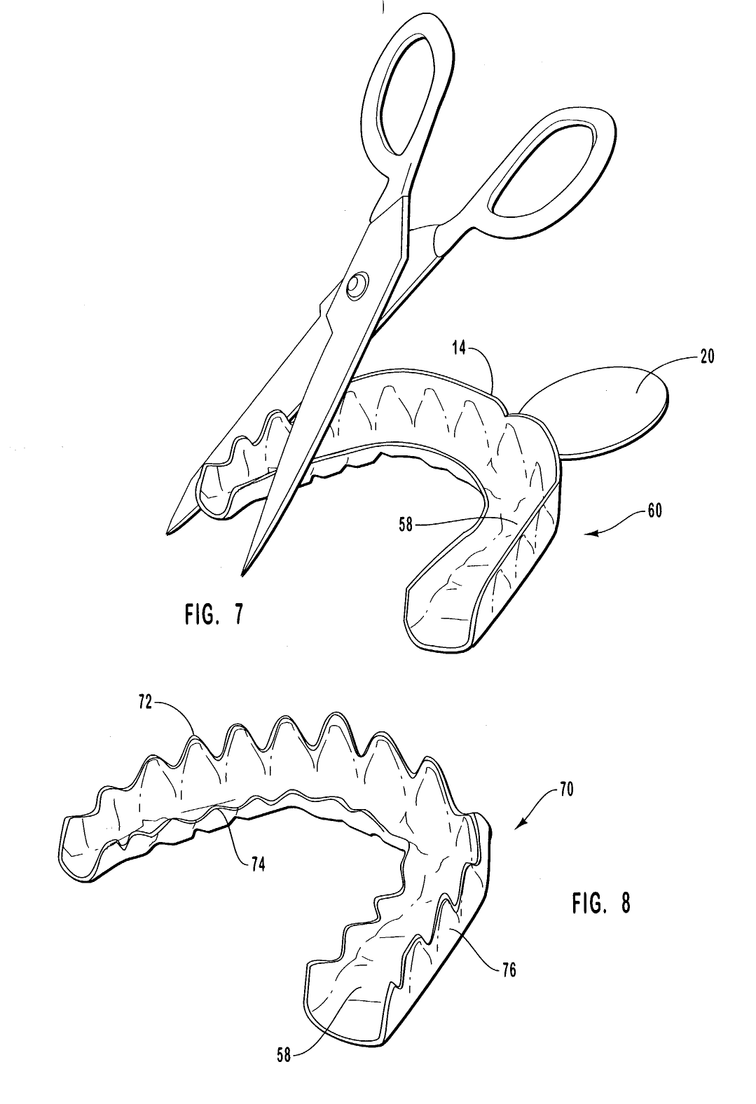

After the preformed tray 10 has been adapted so as to correspond to the person's teeth and has remained in the person's mouth for a significant period of time, it will naturally begin to cool. After the tray 10 has been customized so as to form an impression 58 within the intermediate customized tray 60 (FIG. 7) and is no longer plastically deformable, it is taken out of the mouth. It may be further cooled as desired, such as by placing the intermediate customized tray 60 in cold water or by letting it cool to room temperature. When cooled sufficiently, the impression 58 within the final customized tray 70 (FIG. 8) will become permanent. That is, the tray material can then be deformed to the extent that it is flexible, but because of its resiliency it will return to its original customized shape upon removal of the deformation force. If additional plastic deformation is needed, either immediately or later, the customized trays 60, 70 may be heated so as to become plastically deformable, plastically deformed, and then cooled as described above.

Although the preformed tray is most useful for forming a customized tray directly over a patient's teeth, it is within the scope of the invention to use a preformed tray to form a customized tray over a stone cast.

Once the intermediate customized tray 60 has been formed using the preformed tray 10, the severable handle 20 can be removed, such as by cutting or tearing. Because the handle 20 is advantageously attached at only the two end points 24, removal is easy and leaves a relatively clean and smooth surface. The customized trays 60, 70 may be sanded or otherwise smoothed at the small points where the severable handle 20 was cut or removed so as to remove any roughness that might cause discomfort to the patient. Preferably, the handle 20 is attached to the tray at the top of the front wall 14, so that when the tray is optionally trimmed, the handle and end points 24 are removed during trimming, leaving no rough area at all.

As shown in FIG. 7, once formed, the intermediate customized tray 60 formed by whatever means can be trimmed as desired to yield a finished customized tray of a desired shape, such as to yield the finished tray 70 depicted in FIG. 8. In one embodiment, the customized dental tray can be trimmed so as to terminate at or shy of the gingival margin on both frontal and lingual surfaces. It may be desirable to scallop or trim the customized dental tray up and around interdental papilla so that the finished tray does not overlap them so as to achieve maximum patient comfort.

In general, the customized dental tray can be trimmed to cover a portion of the teeth, just the teeth, or to cover a portion of the gingival margin in addition to the teeth. In one embodiment, it may be desirable to trim the customized dental tray so that enough tray material is left to assure that all of the tooth can be covered to within about ¼ mm to about ⅓ mm of the gingival margin.

As shown generally in FIG. 8, the finished tray 70 comprises a front upper periphery 72 that overlaps a desired portion of the person's frontal tooth surfaces, and optionally at least a portion of the gingiva, when in use. The dental tray may also include a rear upper periphery 74 that overlaps a desired portion of the person's lingual tooth surfaces when in use. The front upper periphery 72 and (if present) the optional rear upper periphery 74 comprise the “upper periphery” of the customized dental tray. The finished tray 70 further also includes a main body portion 76 having an impression 58 formed therein.

The finished customized dental trays according to the invention are useful for teeth bleaching or other dental treatments. In use, a desired dental composition is placed within the main body portion of the tray and the tray is placed over the person's teeth. The customized tray holds and maintains the dental composition against the person's teeth. The customized dental trays according to the invention can be used once or repeatedly as desired.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A preformed tray for use in forming a customized dental tray comprising a thermoplastic material, the preformed tray further comprising:
a bottom wall that is anatomically curved to approximate the curve of Spee of a patient's teeth;
a front side wall extending from an outer edge of said bottom wall; and
an interior defined by the bottom wall and front side wall that is sized and configured to receive a person's teeth.

2. A preformed tray as defined in claim 1, said thermoplastic material comprising at least one of an low density polyethylene, ethylene vinyl acetate, polycaprolactone, polypropylene, or another type of polyethylene.

3. A preformed tray as defined in claim 1, said thermoplastic material comprising ultra low density polyethylene.

4. A preformed tray as defined in claim 1, said bottom wall having a thickness in a range of about 0.8 mm to about 4 mm.

5. A preformed tray as defined in claim 1, said bottom wall having a thickness in a range of about 1.2 mm to about 3 mm.

6. A preformed tray as defined in claim 1, said bottom wall having a thickness in a range of about 1.6 mm to about 2.6 mm.

7. A preformed tray as defined in claim 1, said front side wall having a thickness in a range of about 0.6 mm to about 3.6 mm.

8. A preformed tray as defined in claim 1, said front side wall having a thickness in a range of about 0.8 mm to about 2.8 mm.

9. A preformed tray as defined in claim 1, said front side wall having a thickness in a range of about 1.4 mm to about 2.4 mm.

10. A preformed tray as defined in claim 1, said preformed dental tray being plastically deformable at a temperature in a range of about 110° to about 180° F.

11. A preformed tray as defined in claim 1, said preformed dental tray being plastically deformable at a temperature in a range of about 120° to about 170° F.

12. A preformed tray as defined in claim 1, said preformed dental tray being plastically deformable at a temperature in a range of about 130° to about 160° F.

13. A preformed tray as defined in claim 1, further comprising a handle attached to and extending from a surface of said front side wall.

14. A preformed tray as defined in claim 13, wherein said handle is attached to said front side wall at two spaced-apart points to facilitate removal of said handle from said front side wall.

15. A preformed tray as defined in claim 14, said two points being spaced-apart by a distance of about 20 mm to about 60 mm.

16. A preformed tray as defined in claim 14, said two points being spaced-apart by distance of about 0.5 to about 2 inches.

17. A preformed tray as defined in claim 14, said two points being spaced-apart by distance of about 1.5 inches.

18. A preformed tray as defined in claim 14, said handle being attached near an upper edge of said front side wall.

19. A preformed tray as defined in claim 1, further comprising at least one slot in said bottom wall for maintaining the curvature of said bottom wall.

20. A preformed tray as defined in claim 1, further comprising a rear side wall extending from an inner edge of said bottom wall.

21. A preformed tray for use in forming a customized dental tray comprising a thermoplastic material, the preformed tray further comprising:
a bottom wall that is anatomically curved to approximate the curve of Spee of a patient's teeth, said bottom wall having a thickness in a range of about 0.4 mm to about 2 mm;
a front side wall extending from an outer edge of said bottom wall, said front side wall having a thickness in a range of about 0.3 mm to about 1.8 mm;
a rear side wall extending from an inner edge of said bottom wall, said rear side wall having a thickness in a range of about 0.3 mm to about 1.8 mm; and
an interior defined by the bottom wall and front side wall that is sized and configured to receive a person's teeth.

22. A preformed tray as defined in claim 21, further comprising a handle attached to and extending from a surface of said front side wall.

23. A preformed tray for use in forming a customized dental tray comprising a thermoplastic material, the preformed tray further comprising:
a bottom wall that is anatomically curved to approximate the curve of Spee of a patient's teeth;
a front side wall extending from an outer edge of said bottom wall;
a rear side wall extending from an inner edge of said bottom wall and a severable handle attached to and extending from a surface of said front side wall, said handle being attached to said side wall at two spaced-apart points.
